(19) United States
(12) Patent Application Publication
(10) Pub. No.: US 2025/0264725 A1
(43) Pub. Date: Aug. 21, 2025

(54) WAVEGUIDE BONDING THROUGH BLACKENING INK

(71) Applicant: Applied Materials, Inc., Santa Clara, CA (US)

(72) Inventors: Davide COLLA, Treviso (IT); Xiaopeng YU, Santa Clara, CA (US); Neal RICKS, San Jose, CA (US)

(21) Appl. No.: 19/057,324

(22) Filed: Feb. 19, 2025

Related U.S. Application Data
(60) Provisional application No. 63/555,229, filed on Feb. 19, 2024.

(51) Int. Cl. G02B 27/01

(52) U.S. Cl. CPC G02B 27/0176

(57) ABSTRACT

Embodiments of the present disclosure generally relate to a device with a substrate with a first surface, a second surface, and an edge where the first surface of the substrate includes a waveguide, where the waveguide includes an input coupling grating, a pupil expansion grating, and an output coupling grating. The device additionally includes a cover substrate, a blackening section disposed over the first surface between the edge of the substrate and the waveguide, and a gap between the substrate and the cover substrate. A method includes disposing blackening material over the substrate, placing a cover substrate on the blackening material and curing to form a blackening section. Another method includes disposing blackening material over the substrate, curing the blackening material to form a blackening section, disposing adhesive over the blackening section, curing the adhesive, and placing a cover substrate on the adhesive.

### CROSS-REFERENCE TO RELATED APPLICATION

This application claims the benefit of U.S. Provisional Patent Application No. 63/555,229, filed Feb. 19, 2024, which is incorporated by reference herein in its entirety.

### BACKGROUND

### Field

Embodiments of the present disclosure generally relate to waveguides. More specifically, embodiments described herein relate to a waveguide having a blackening section disposed over at least one surface and a method of forming the blackening section over the over at least one surface of the waveguide.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

Waveguides, such as augmented reality waveguides, are used to overlay virtual images over the ambient environment. Generated light is propagated through a waveguide until the light exits the waveguide and is overlaid on the ambient environment. A challenged occurs when light is propagated through the waveguide and exits the waveguide through the edge. The light exiting the waveguide at through the edge is visible to an external viewed. Another challenge occurs when a fraction of light bounces back into the waveguide after contact the edge of the optical device. The bounce back of light reduces the device performance. Waveguides may require coating one or more edges of the waveguide with a blackening material to prevent light bouncing back into the waveguide or exiting the waveguide through the edge.

Accordingly, what is needed in the art is a waveguide having at least one side partially coated with a blackening material and a method of disposing the blackening material over the waveguide.

### SUMMARY

In one embodiment, a device is provided. The device includes a substrate with a first surface, a second surface and an edge where the first surface of the substrate includes a waveguide, where the waveguide includes an input coupling grating, a pupil expansion grating, and an output coupling grating. The device further includes a cover substrate, a blackening section disposed over the first surface of the substrate between the edge of the substrate and the waveguide, and a gap between the substrate and the cover substrate.

In another embodiment, a method is provided. The method includes forming a blackening layer on at least an edge of a substrate, the substrate having a first surface and a second surface, the first surface including a waveguide including at least one grating disposed over the first surface of the substrate, disposing blackening material over the first surface where the blackening material is disposed between the grating and the edge of the substrate, placing a cover substrate on the blackening material, and curing the blackening material to form a blackening section and bond the cover substrate to the blackening section.

In yet another embodiment, a method is provided. The method includes disposing blackening material over a first surface of a substrate, the substrate having a first surface and a second surface, wherein the first surface comprises a waveguide, the blackening material is disposed between a grating and the edge of the waveguide substrate, curing the blackening material to form a blackening section, disposing an adhesive over the blackening section, curing the adhesive, and placing a cover substrate on the adhesive.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIGS. 1A and 1B are perspective, front views of a waveguide, according to certain embodiments.

FIGS. 2A and 2B are schematic, cross-sectional views, according to certain embodiments.

FIGS. 3A and 3B are schematic, cross-sectional view, according to certain embodiments.

FIG. 4 is a flow diagram of a method of fabricating a waveguide with a blackening layer configuration, according to certain embodiments.

FIGS. 5A-5D are schematic, cross-sectional views of a substrate during fabrication of a waveguide with a blackening layer configuration, according to certain embodiments.

FIG. 6 is a flow diagram of a method of fabricating a waveguide with a blackening section configuration, according to certain embodiments.

FIGS. 7A-7F are schematic, cross-sectional views of a substrate during fabrication of a waveguide with a blackening section configuration, according to certain embodiments.

FIG. 8 is a schematic, top view of a substrate during fabrication of a waveguide, according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to optical devices. More specifically, embodiments described herein relate to a waveguide having at least one surface partially coated with a blackening section and a method of disposing the blackening section over the waveguide. In some embodiments, blackening sections are disposed over portions of the surface and a blackening layer is disposed on the edge of the substrate. In other embodiments, a blackening section is disposed around the circumference of the surface.

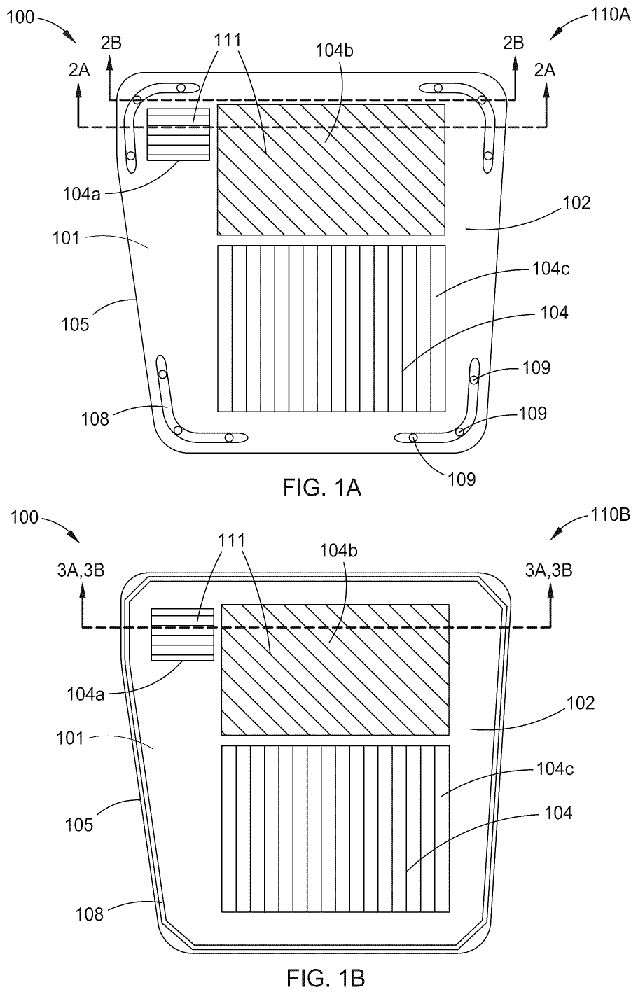

FIGS. 1A and 1B are perspective, frontal views of a waveguide 100. The waveguide 100 of FIG. 1A corresponds to a blackening layer configuration 110A further described herein. The waveguide 100 of FIG. 1B corresponds to a blackening section configuration 110B further described herein. It is to be understood that the waveguide 100 described herein is an exemplary waveguide and that other waveguides may be used with or modified to accomplish aspects of the present disclosure. The waveguide 100 includes a plurality of structures 111. The structures 111 may be disposed over, under, or on a first surface 102 of a substrate 101, or disposed in the substrate 101. The structures 111 are nanostructures and have a sub-micron critical dimension, e.g., a width less than 1 micrometer. Regions of the structures 111 correspond to one or more gratings 104. In one embodiment, which can be combined with other embodiments described herein, the waveguide 100 includes at least a first grating 104a corresponding to an input coupling grating and a third grating 104c corresponding to an output coupling grating. In another embodiment, which can be combined with other embodiments described herein, the waveguide 100 further includes a second grating 104b. The second grating 104b corresponds to a pupil expansion grating or a fold grating.

The substrate 101 may also be selected to transmit a suitable amount of light of a desired wavelength or wavelength range, such as one or more wavelengths from about 100 to about 3000 nanometers. Without limitation, in some embodiments, the substrate 101 is configured such that the substrate 101 transmits greater than or equal to about 50% to about 100%, of an infrared to ultraviolet region of the light spectrum. The substrate 101 may be formed from any suitable material, provided that the substrate 101 can adequately transmit light in a desired wavelength or wavelength range and can serve as an adequate support for the waveguide 100 described herein. Substrate selection may include optical device substrates of any suitable material, including, but not limited to, amorphous dielectrics, non-amorphous dielectrics, crystalline dielectrics, silicon oxide, polymers, and combinations thereof. In some embodiments, which may be combined with other embodiments described herein, the substrate 101 includes a transparent material. In one embodiment, which may be combined with other embodiments described herein, the substrate 101 is transparent with absorption coefficient smaller than 0.001. Suitable examples may include silicon (Si), silicon dioxide (SiO₂), fused silica, quartz, silicon carbide (SiC), germanium (Ge), silicon germanium (SiGe), indium phosphide (InP), gallium arsenide (GaAs), gallium nitride (GaN), sapphire, lithium tantalate (LiTaO₃), lithium niobate (LiNbO₃), or combinations thereof. In some embodiments, which may be combined with other embodiments described herein, the substrate 101 has a substrate refractive index greater than 1.4, such as greater than 1.6, such as about 1.8, or about 2.0. In some embodiments, the refractive index of the blackening material 106 is less than about 40% of the refractive index of the substrate 101. In some embodiments, the substrate refractive index and the blackening refractive index are substantially the same. In some embodiments, the substrate refractive index and the blackening refractive index are substantially the same.

In some embodiments, the structures 111 are disposed in the substrate 101. In other embodiments, the structures 111 are disposed on or over the substrate 101. In these embodiments, the structures 111 include a device material. The device material includes, but is not limited to, silicon carbide (SiC), silicon oxycarbide (SiOC), titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), silicon mononitride (SIN), silicon oxynitride (SiON), barium titanate (BaTiO₃), diamond like carbon (DLC), hafnium (IV) oxide (HfO₂), lithium niobate (LiNbO₃), silicon carbon-nitride (SiCN), or combinations thereof.

In operation of the waveguide 100 a virtual image is projected from a near-eye display, such as a microdisplay, to the first grating 104a. The structures 111 of the first grating 104a in-couple the incident beams of light of the virtual image and diffract the incident beams to the second grating 104b. The diffracted beams undergo total-internal-reflection (TIR) until through the waveguide 100 until the diffracted beams come in contact with structures 111 of the second grating 104b. The diffracted beams from the first grating 104a incident on the second grating 104b are split into a first portion beams refracted back or lost in the waveguide 100, a second portion beams that undergo TIR in the second grating 104b until the second portion beams contact another structure of the plurality of structures 111 of the second grating 104b, and a third portion of beams that are coupled through the waveguide 100 to the third grating 104c. The beams of the second portion of beams that undergo TIR in the second grating 104b continue to contact structures of the plurality of structures until the either the intensity of the second portion of beams coupled through the waveguide 100 to the second grating 104b is depleted, or remaining second portion of beams propagating through the second grating 104b reach the end of the second grating 104b.

The beams pass through the waveguide 100 to the third grating 104c and undergo TIR in the waveguide 100 until the beams contact a structure of the plurality of gratings 104 of the third grating 104c where the beams are split into beams that are refracted back or lost in the waveguide 100, beams that undergo TIR in the third grating 104c until the beams contact another structure of the plurality of gratings 104, or beams that are out-coupled from the waveguide 100 to the user's eye. The beams that undergo TIR in the third grating 104c continue to contact structures of the plurality of gratings 104 until the either the intensity of the beams pass through the waveguide 100 to the third grating 104c is depleted, or remaining beams propagating through the third grating 104c have reached the end of the third grating 104c. The beams of the virtual image are propagated from the third grating 104c to overlay the virtual image over the ambient environment.

Some light provided to the waveguide 100 strays from the intended path discussed above. For example, in some instances, a fraction of beams, i.e., stray light, reaches an edge 105 of the waveguide 100. Upon reaching the edge 105, the stray light can then be transmitted through the edge 105, reflected, or scattered, through the waveguide 100 at a variety of angles, or absorbed at the edge 105. Stray light that is transmitted through the edge 105 and/or stray light bounces from the edge 105 back through the waveguide 100 reduce the quality of virtual image via noise from the stray light. To reduce the amount of stray light transmitted through the edge 105 and the amount of stray light scattered in the waveguide 100 by the edge 105 the waveguide 100 includes a blackening layer configuration 110A or a blackening section configuration 110B. The blackening layer 107 prevents light from bouncing back into the waveguide 100 after hitting the edge 105. If light bounces back into the waveguide 100 it will negatively affect the performance of the waveguide 100 because it causes a low contrast. The blackening layer 107 improves performance by having a refractive index as close to the refractive index that is substantially similar to the substrate refractive index. The light will leave the waveguide 100 and enter the blackening layer 107 because there is no optical discontinuity between the two materials. Additionally, the blackening layer 107 acts to absorb the light, which prevents the light from bouncing back into the waveguide 100. The blackening layer configuration 110A of the waveguide 100 includes blackening sections 108 of blackening material 106 disposed over portions of at least the first surface 102 and a blackening layer 107 of the blackening material 106 disposed on the edge 105 of the substrate 101. The blackening section configuration 110B of the waveguide 100 includes a blackening section 108 that is disposed on at least a first surface 102 of the substrate 101 or the circumference of the substrate 101.

The blackening material 106 forms a blackening layer 107 on at least the edge 105 of the substrate 101. Blackening material 106 is disposed on the first surface 102 of the substrate 101. The blackening material 106, when cured, forms a blackening section 108. The blackening section 108 provides further assistance in reducing stray light transmitted through the waveguide. The blackening section 108 captures stray light as it bounces at different angels within the waveguide 100. Stray light is captured wherever a blackening section 106 has been applied on a first surface 102, or in some embodiments on the first surface 102 and the second surface 103.

The blackening material 106 of the blackening section 108 and the blackening layer 107 has a refractive index that is substantially similar to the refractive index of the substrate. In some embodiments, which may be combined with other embodiments described herein, the substrate 101 has a substrate refractive index greater than 1.4, such as greater than 1.6, such as about 1.8, or about 2.0. In some embodiments, the refractive index of the blackening material 106 is less than about 40% of the refractive index of the substrate 101. In some embodiments, the substrate refractive index and the blackening refractive index are substantially the same.

To obtain the blackening refractive index, the blackening material 106 includes a blacking ink, a siloxane-containing resin, or combinations thereof. The blackening material 106 includes, but is not limited to, one or more dyes, one or more pigments, a polymer mix of one or more binders, or combinations thereof. The blackening material 106 may further include one or more filler dispersions, one or more photoinitiator, one or more epoxy resin, one or more additives, one or more silanes, one or more isocyanates, one or more acids, one or more phosphine oxides, or combinations thereof.

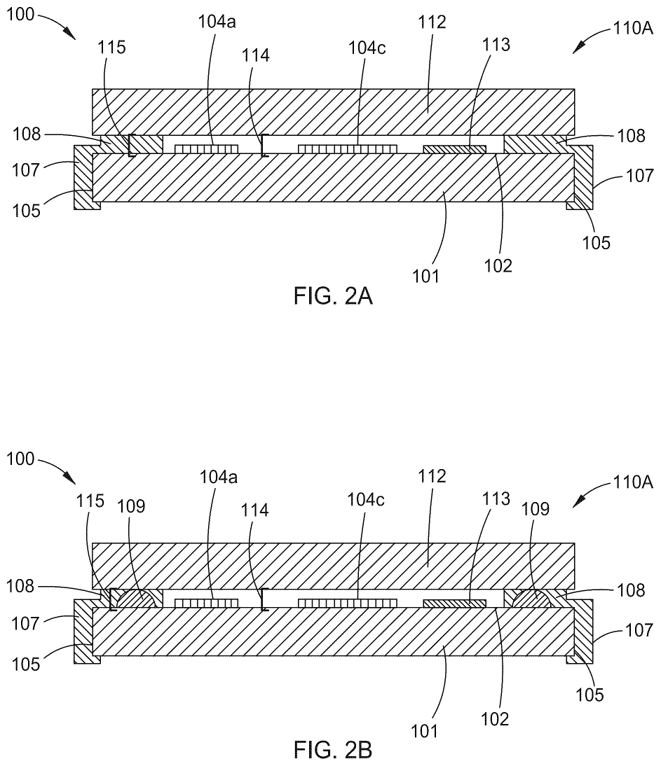

FIGS. 2A and 2B are schematic, cross-sectional views of a waveguide 100. The waveguide 100 of FIGS. 2A and 2B has blackening layer configuration 110A. FIG. 2A is a cross-section along line 2A-2A as shown in FIG. 1A. FIG. 2B is a cross-section along line 2B-2B shown in FIG. 1A. As shown in FIG. 2A, the blackening section 108 is disposed over the first surface 102 between the gratings 104 and the edge 105 of the substrate 101. The blackening layer 107 is disposed on at least the edge 105 of the substrate 101. The blackening section 108 is disposed on the first surface 102 and contacts the blackening layer 107. In some embodiments, the blackening section 108 is disposed on the second surface 103 of the substrate 101. The blackening section 108 and the blackening layer 107 reduce the amount of stray light transmitted through the edge 105 or peripheral of the first surface 102 and the amount of stray light scattered back into the waveguide 100 from the edge 105 or peripheral of the first surface 102. A cover substrate 112 is coupled to the blackening section 108. A space 114 is defined by the blackening section 108, the cover substrate 112, and the first surface 102 of the substrate 101. The thickness 115 of the blackening section 108 provides for the size of the space 114. The composition of the space 114 includes air having a refractive index of 1.0 and an absorption coefficient of 0. A mirror coating 113 is disposed on the first surface 102 of the substrate 101. The mirror may be disposed between one of the gratings 104 and the blackening section 108.

As shown in FIG. 2B, the blackening material 106 is disposed over gap setting features 109. A gap setting feature 109 may be a pressure sensitive adhesive or a glue. At least one gap setting feature 109 is disposed over the first surface 102 of the substrate 101 between the edge 105 of the substrate and at least one of the gratings 104. The blackening material 106 surrounds the gap setting features 109. The thickness 115 of the blackening material 106 is the same as the height of the gap setting features 109. The blackening material 106 is soaked into the gap setting features 109 such that the blackening material 106 and the gap setting features 109, once cured, form a single blackening section 108. A cover substrate 112 is coupled to the blackening section 108. A space 114 is defined by the blackening section 108, the cover substrate 112, and the first surface 102 of the substrate 101. The thickness 115 of the blackening section 108 provides for the size of the space 114. The composition of the space 114 includes air having a refractive index of less than 1.0 and an absorption coefficient of 0. A space 114 is desirable to prevent undesirable optical effects such as interference. The space 114 between the cover substrate 112 and the substrate 101 has a height of less than or equal to about 0.20, or about 0.15 mm, or about 0.10, or about 0.030 mm, or about 0.050 mm, or about 0.0025 mm.

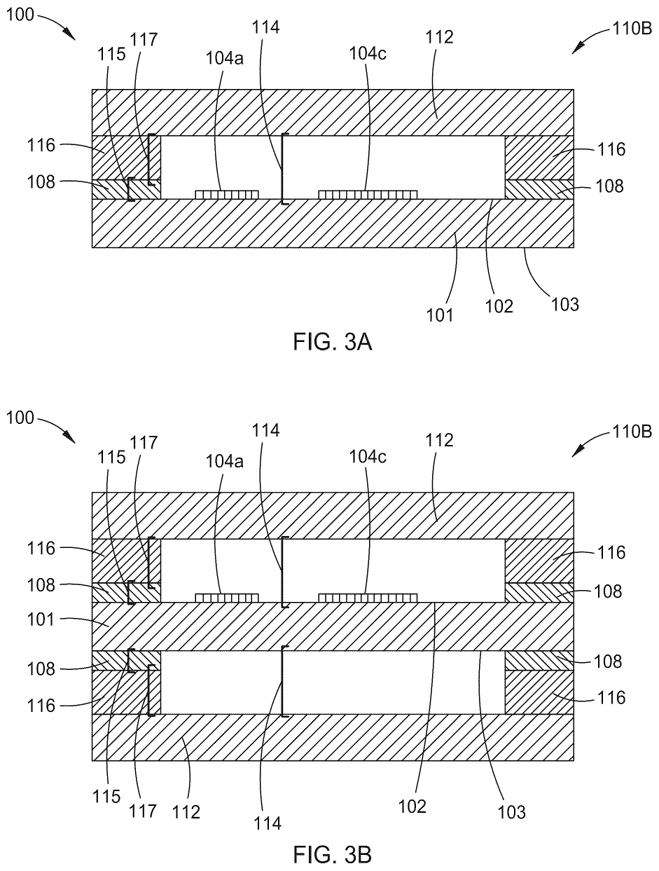

FIGS. 3A and 3B are schematic, cross-sectional views of a waveguide 100. The waveguide 100 of FIGS. 3A and 3B has blackening section configuration 110B. FIG. 3A and FIG. 3B are cross-sections along line 3A,3B-3A,3B, as shown in FIG. 1B. As seen in FIG. 3A, the blackening section 108 is disposed over the first surface 102 of the substrate 101 between the gratings 104 and the edge 105 of the substrate 101. An adhesive 116 is disposed over the blackening section 108. The adhesive 116 may be a pressure sensitive adhesive or a glue. A cover substrate 112 is coupled to the adhesive 116. A space 114 is defined by the blackening section 108, the adhesive 116, the substrate 101, and the cover substrate 112. The thickness 115 of the blackening section 108 and the adhesive 116 provides the size of the space 114. The composition of the space 114 includes air having a refractive index of less than 1.4 and an absorption coefficient of 0. A space 114 is desirable to prevent undesirable optical effects such as interference. The space 114 between the cover substrate 112 and the substrate 101 has a height of less than or equal to 0.1 mm, such as less than 0.050 mm, such as about 0.030 mm, about 0.020 mm or about 0.0025 mm.

As show in FIG. 3B, the blackening section 108 is disposed over the first surface 102 of the substrate 101 between the gratings 104 and the edge 105 of the substrate 101 and the second surface 103 of the substrate 101. An adhesive 116 is disposed over the blackening section 108 on the first surface 102 of the substrate 101 and the second surface 103 of the substrate 101. A cover substrate 112 is coupled to the adhesive 116 on the first surface 102 and the second surface 103 of the substrate 101. A space 114 is defined by the blackening section 108, the adhesive 116, the substrate 101, and the cover substrate 112 on both the first surface 102 and the second surface 103 of the substrate. The thickness 115 of the blackening section 108 and the thickness 117 of the adhesive 116 provides the size of the space 114. The thickness 115 of the blackening section 108 and the thickness 117 of the adhesive 116 is substantially similar on the first surface 102 and the second surface 103 of the substrate. The composition of the space 114 includes air having a refractive index of less than 1.4 and an absorption coefficient of 0. A space 114 is desirable to prevent undesirable optical effects such as interference. The space 114 between the cover substrate 112 and the substrate 101 has a height of less than or equal to 0.1 mm, such as less than 0.050 mm, such as about 0.030 mm, about 0.020 mm or about 0.0025.

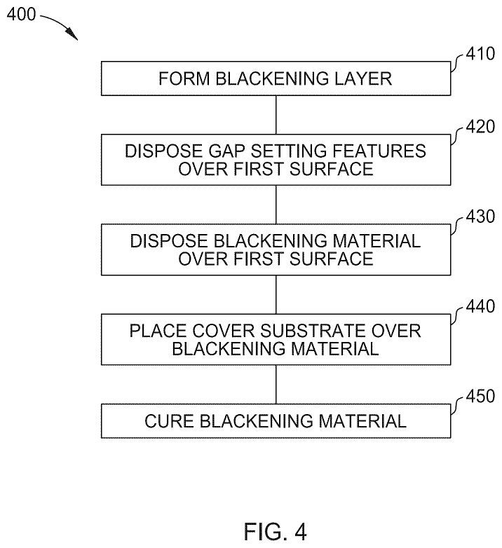

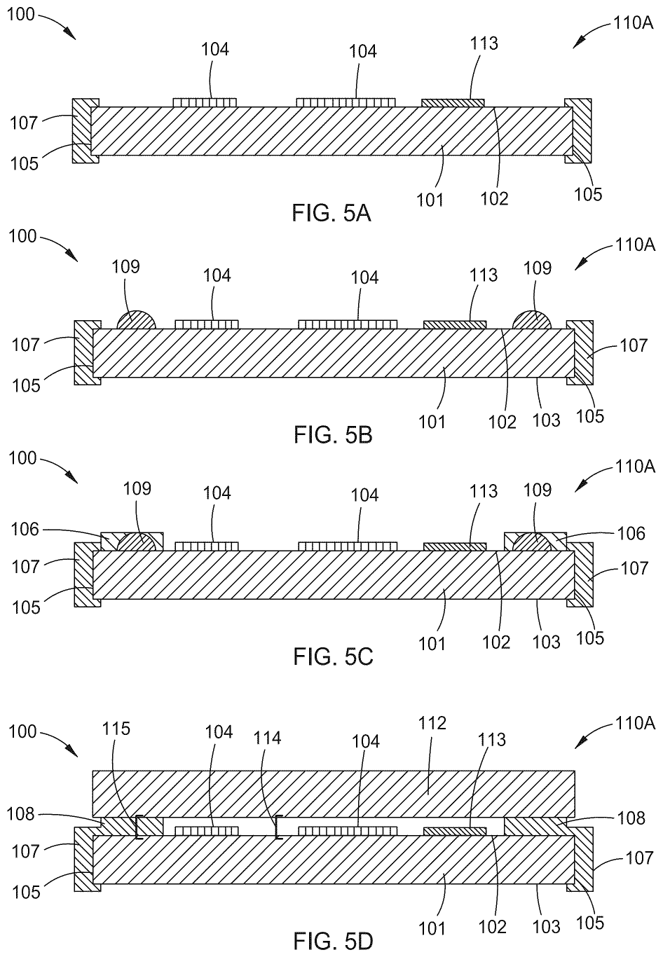

FIG. 4 is a flow diagram of a method 400 of fabricating a waveguide 100 with a blackening layer 107 and a blackening section 108. FIGS. 5A-5E are cross-sectional views of a substrate 101 during fabrication of a waveguide with a blackening layer configuration 110A according to embodiments. In one or more embodiments, a plurality of waveguides 800 (e.g., more than one waveguide 100) are formed on the substrate 101, as shown in FIG. 8. The plurality of waveguides 800 are fabricated according to operation 420, 430, 440, and 450 of method 400 on the substrate 101. After operation 450, the plurality of waveguides 800 formed on the substrate 101 are singulated into one or more individual waveguides 100 (e.g., each waveguide 100 is cut and removed from the substrate 101). After singulation, a blackening layer 107 is formed on the edge 105 substrate 101 (e.g., on the edge 105 of the substrate 101 that was singulated where each substrate 101 includes a waveguide 100) to form the waveguide 100 as shown in FIG. 5E.

At operation 410, a blackening layer 107 is formed on a substrate 101. For example, as shown in FIG. 5A, the blackening layer 107 is formed on an edge 105 of the substrate 101. To form the blackening layer 107, the blackening material 106 is disposed on at least the first surface 102 of the substrate 101. The blackening material 106 is then cured to for the blackening layer 107. The blackening material 106 may be cured via UV curing. The blackening layer 107 is cured, so that it forms a hardened layer around the edge 105 of the substrate 101.

The blackening material includes a blacking ink, a siloxane-containing resin, or combinations thereof. The blackening material 106 additionally may include, but is not limited to, or more dyes, one or more pigments, a polymer mix of one or more binders, or combinations thereof. The blackening material 106 may further include one or more filler dispersions, one or more photoinitiator, one or more epoxy resin, one or more additives, one or more silanes, one or more isocyanates, one or more acids, one or more phosphine oxides, or combinations thereof. The blackening material 106 of the blackening section 108 and the blackening layer 107 has a refractive index that is substantially similar to the refractive index of the substrate. In some embodiments, which may be combined with other embodiments described herein, the substrate 101 has a substrate refractive index greater than 1.4, such as greater than 1.6, such as about 1.8, or about 2.0. In some embodiments, the refractive index of the blackening material 106 is less than about 40% of the refractive index of the substrate 101. In some embodiments, the substrate refractive index and the blackening refractive index are substantially the same.

In a first optional operation, a mirror coating 113 is disposed on the first surface 102 of the substrate 101 by a FEOL process step. The mirror coating 113 may be disposed between one of the gratings 104 and the blackening section 108 to be formed.

At an optional operation 420, gap setting features 109 are disposed on the first surface 102 of the substrate 101. The gap setting features 109 are hard cured by a UV or thermal curing process.

At operation 430 a blackening material 106 is disposed over the first surface 102 of the substrate 101, as shown in FIG. 5C. The blackening material 106 used to create the blackening layer 107 is substantially the same as the blackening material disposed over the at least the first surface 102 of the substrate 101. The blackening material 106 is disposed by screen printing, dispensing or inkjet printing over the substrate 101. In some embodiments, the blackening section 108 is disposed on the second surface 103 of the substrate 101. The blackening layer 107 prevents light from bouncing back into the waveguide 100 after hitting the edge 105. If light bounces back into the waveguide 100 it will negatively affect the performance of the waveguide 100 because it causes a low contrast. The blackening layer 107 improves performance by having a refractive index as close to the refractive index that is substantially similar to the refractive index of the substrate 101. The light will leave the waveguide 100 and enter the blackening layer 107 because there is no optical discontinuity between the two materials. Additionally, the blackening layer 107 acts to absorb the light, which prevents the light from bouncing back into the waveguide 100. The blackening section 108 captures stray light as it bounces at different angels within the waveguide 100. Stray light is captured wherever a blackening section 106 has been applied on a first surface 102, or in some embodiments on the first surface 102 and the second surface 103.

In another embodiment, including the gap setting features 109, the blackening material 106 is disposed over the gap setting features 109. The blackening material 106 is soaked into the gap setting features 109 such that the blackening material 106 and the gap setting features 109, once cured, form a single blackening section 108, as seen in FIG. 5D.

At operation 440, a cover substrate 112 is disposed over the blackening material 106, as shown in FIG. 5D. At operation 450, the blackening material 106 is cured to bond the cover substrate 101 to the blackening section 108, as shown in FIG. 5D. When cured, the blackening material 106 creates a blackening section 108. The blackening section 108 contacts the blackening layer 107. The gap setting features 109 may also contact the cover substrate 112. The curing creates a laminate seal. A space 114 is defined by the blackening section 108, the cover substrate 112, and the first surface 102 of the substrate 101. The thickness 115 of the blackening section 108 provides for the size of the space 114. The thickness 115 of the blackening section 108 is defined by the height of the gap setting features 109 in embodiments including the gap setting features 109. The composition of the space 114 includes air having a refractive index of less than 1.4 and an absorption coefficient of 0. A space 114 is desirable to prevent undesirable optical effects such as interference. The space 114 between the cover substrate 112 and the substrate 101 has a height of less than or equal to 0.1 mm, such as less than 0.050 mm, such as about 0.030 mm, about 0.020 mm or about 0.0025.

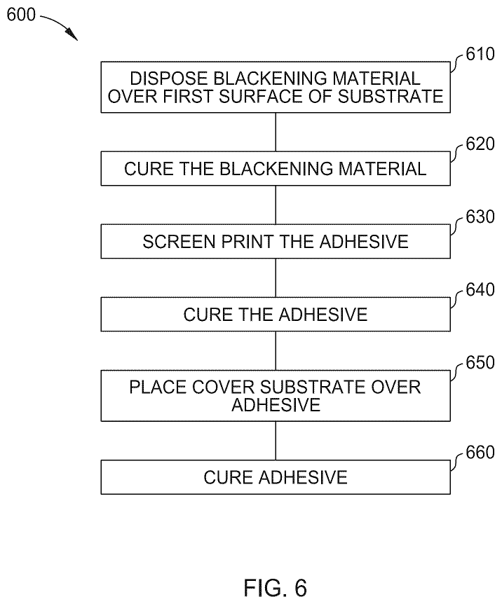

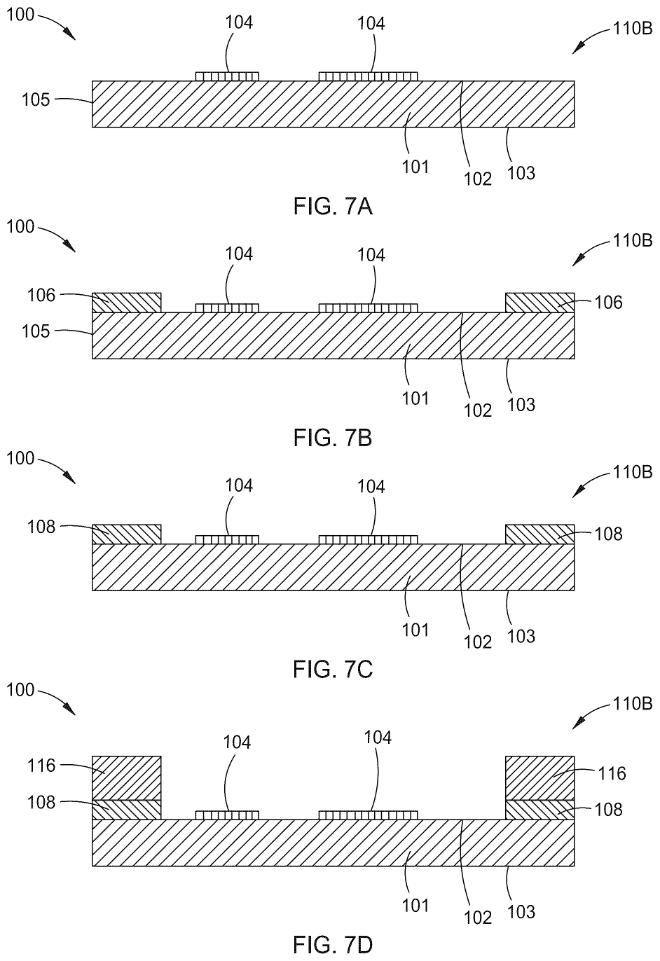

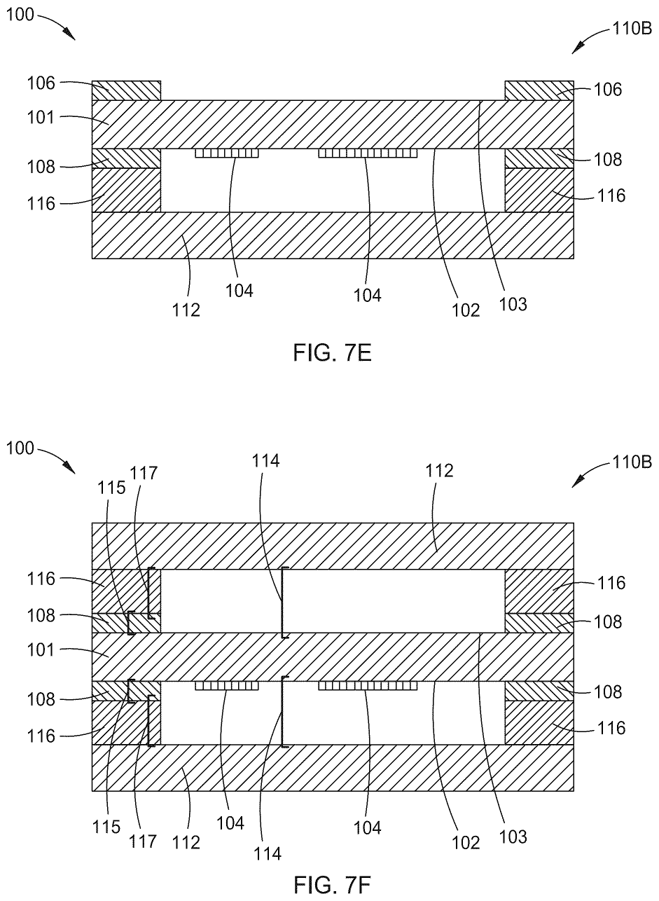

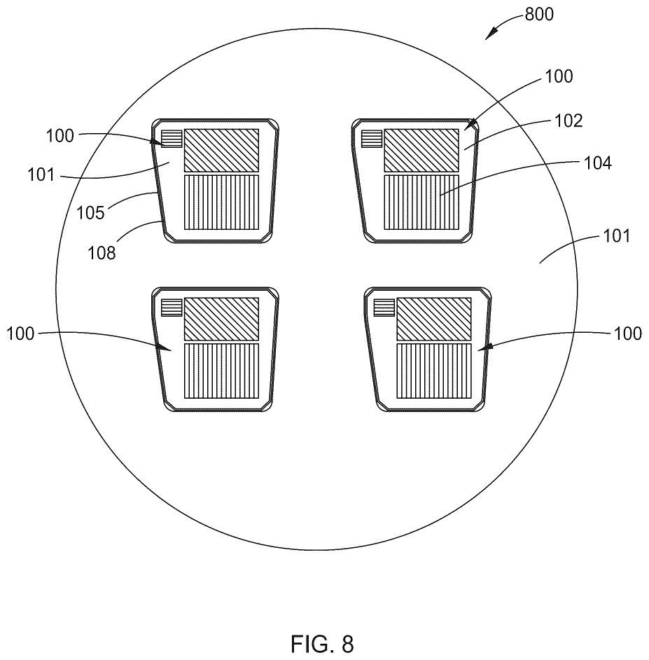

FIG. 6 is a flow diagram of a method 600 of fabricating a waveguide 100 with a blackening section configuration 110B. FIGS. 7A-7F are cross-sectional views of a substrate during fabrication of a waveguide with a blackening section configuration 110B according to embodiments. At operation 610, blackening material 106 is disposed over a substrate 101. The blackening material includes a blacking ink, a siloxane-containing resin, or combinations thereof. The blackening material 106, additionally, may include, but is not limited to, or more dyes, one or more pigments, a polymer mix of one or more binders, or combinations thereof. The blackening material 106 may further include one or more filler dispersions, one or more photoinitiator, one or more epoxy resin, one or more additives, one or more silanes, one or more isocyanates, one or more acids, one or more phosphine oxides, or combinations thereof. The blackening material 106 of the blackening section 108 includes a refractive index that is substantially similar to the refractive index of the substrate. In one or more embodiments, the waveguide 100 includes the blackening layer (e.g., the blackening layer shown in FIG. 5A-5D). In some embodiments, which may be combined with other embodiments described herein, the substrate 101 has a substrate refractive index greater than 1.4, such as greater than 1.6, such as about 1.8, or about 2.0. In some embodiments, the refractive index of the blackening material 106 is less than about 40% of the refractive index of the substrate 101. In some embodiments, the substrate refractive index and the blackening refractive index are substantially the same.

The substrate 101 includes a first surface 102, a second surface 103 and at least one grating 104, as seen in FIG. 7A. The blackening material 106 is disposed over the first surface 102 of the substrate 101 between at least one of the gratings 104 and an edge 105 of the substrate 101, as seen in FIG. 7B. The blackening material 106 is disposed by screen printing or inkjet printing.

At operation 620, the blackening material 106 is cured by a UV or thermal process to create a blackening section 108, as seen in FIG. 7C. The blackening section 108 improves performance by having a refractive index as close to the refractive index that is substantially similar to the refractive index of the substrate 101. The light will leave the waveguide 100 and enter the blackening section 108 because there is no optical discontinuity between the two materials. Additionally, the blackening section 108 acts to absorb the light, which prevents the light from bouncing back into the waveguide 100.

At operation 630, an adhesive 116 is disposed over the blackening section 108, as seen in FIG. 7D. The adhesive 116 is disposed over the blackening section 108 by screen printing. In one or more embodiments, at operation 640, the adhesive 116 is cured. In one or more embodiments, the adhesive 116 is cured by a UV, a thermal curing process, or any other reasonable means of curing. At operation 650 a cover substrate 112 is placed over the adhesive 116, as seen in FIG. 7E. In embodiments where the adhesive 116 is a pressure sensitive adhesive, the cover substrate 112 is pressed slightly on the adhesive 116. The pressure activates the adhesive 116 to form a bond between the blackening section 108 and the cover substrate 112. In embodiments where the adhesive 116 is a glue, a gap setting feature 109 may be used to maintain the defined space 114 between the substrate 101 and the cover substrate 112. A space 114 is defined by the blackening section 108, the adhesive 116, the substrate 101, and the cover substrate 112 on both the first surface 102 and the second surface 103 of the substrate. The thickness 115 of the blackening section 108 and the thickness 117 of the adhesive 116 provides the size of the space 114. The thickness 115 of the blackening section 108 and the thickness 117 of the adhesive 116 is substantially similar on the first surface 102 and the second surface 103 of the substrate. The composition of the space 114 includes air having a refractive index of less than 1.4 and an absorption coefficient of 0. A space 114 is desirable to prevent undesirable optical effects such as interference. The space 114 between the cover substrate 112 and the substrate 101 has a height of less than or equal to 0.1 mm, such as less than 0.050 mm, such as about 0.1 mm, such as about 0.030 mm, about 0.020 mm or about 0.0025. In one or more embodiments, at operation 650, the adhesive 116 is cured, such that the cover substrate 112 is secured to the blackening section 108 which secures the cover substrate 112 to the substrate 101. In one or more embodiments, at operation 660, the adhesive 116 is cured. In one or more embodiments, operation 660 is a first cure of the adhesive 116. In one or more embodiments, operation 660 is a second cure of the adhesive 116. In one or more embodiments, the adhesive 116 is cured by a UV, a thermal curing process, or any other reasonable means of curing.

In some embodiments, method 600 is repeated on the second surface 103 of the substrate 101, as seen in FIG. 7E. The blackening section 108 is disposed over the first surface 102 of the substrate 101 between the gratings 104 and the edge 105 of the substrate 101 and the second surface 103 of the substrate 101 by screen printing. An adhesive 116 is disposed over the blackening section 108 on the first surface 102 of the substrate 101 and the second surface 103 of the substrate 101 by screen printing. A cover substrate 112 is coupled to the adhesive 116 on the first surface 102 and the second surface 103 of the substrate 101. A space 114 is defined by the blackening section 108, the adhesive 116, the substrate 101, and the cover substrate 112 on both the first surface 102 and the second surface 103 of the substrate. The thickness 115 of the blackening section 108 and the thickness 117 of the adhesive 116 provides the size of the space 114. The thickness 115 of the blackening section 108 and the thickness 117 of the adhesive 116 is substantially similar on the first surface 102 and the second surface 103 of the substrate. The composition of the space 114 includes air having a refractive index of less than 1.4 and an absorption coefficient of 0. A space 114 is desirable to prevent undesirable optical effects such as interference. The space 114 between the cover substrate 112 and the substrate 101 has a height of less than or equal to 0.1 mm, such as less than 0.050 mm, such as about 0.030 mm, about 0.020 mm or about 0.0025.

In one or more embodiments, a plurality of waveguides 800 (e.g., more than one waveguide 100) are formed on the substrate 101, as shown in FIG. 8. The plurality of waveguides 800 are fabricated according to method 600 on the substrate 101. After method 600, the plurality of waveguides 800 disposed on the substrate 101 are singulated into one or more individual waveguides 100 (e.g., the waveguide 100 shown in FIG. 7F). In summary, a waveguide having a blackening section disposed over at least one surface and a method of forming the blackening section over the over at least one surface of the waveguide are described herein. The blackening section is disposed on the surface of the substrate reduce the amount of stray light transmitted through the edge or peripheral of the surface and the amount of stray light scattered in the waveguide by the edge or peripheral of the first surface. The blackening material also functions to bond the cover substrate such that an air-gap is formed between cover substrate and the waveguide.

While the foregoing is directed to embodiments of the present disclosure, other and further embodiments of the disclosure may be devised without departing from the basic scope thereof, and the scope thereof is determined by the claims that follow.

What is claimed is:

1. A device, comprising:
a substrate having a first surface, a second surface, and an edge, wherein the first surface of the substrate comprises a waveguide, wherein the waveguide includes an input coupling grating, a pupil expansion grating, and an output coupling grating;
a cover substrate;
a blackening section disposed over the first surface of the substrate between the edge of the substrate and the waveguide; and
a gap between the substrate and the cover substrate.

2. The device of claim 1, further comprising an adhesive disposed over the blackening section.

3. The device of claim 2, wherein the adhesive is a pressure sensitive adhesive.

4. The device of claim 2, wherein the cover substrate is coupled to the adhesive.

5. The device of claim 1, further comprising a blackening layer on at least the edge of the substrate.

6. The device of claim 5, wherein the blackening section contacts the blackening layer.

7. The device of claim 1, further comprising a gap setting feature wherein the blackening section is disposed on or around the gap setting feature.

8. The device of claim 1, wherein the blackening section defines the gap between the substrate and the cover substrate.

9. The device of claim 1, wherein the blackening section is disposed around a circumference of the first surface.

10. The device of claim 1, wherein the blackening section comprises a blackening material, wherein the blackening material comprises a blacking ink, a siloxane-containing resin, or combinations thereof.

11. The device of claim 1 wherein, a blackening material and the substrate have a refractive index that is substantially similar.

12. The device of claim 11, wherein the refractive index of the substrate is at least 1.4.

13. A method, comprising:
forming a blackening layer on at least an edge of a substrate, the substrate having a first surface and a second surface, the first surface comprising a waveguide comprising at least one grating disposed over the first surface of the substrate;
disposing a blackening material over the first surface, the blackening material disposed between the grating and the edge of the substrate;
placing a cover substrate on the blackening material; and
curing the blackening material to form a blackening section and bond the cover substrate to the blackening section.

14. The method of claim 13, further comprising disposing gap setting features on at least the first surface of the substrate before forming the blackening layer.

15. The method of claim 14, wherein the blackening material is disposed over the gap setting features.

16. The method of claim 15, wherein the gap setting features and the blackening material are screen printed onto the substrate.

17. The method of claim 15, wherein the gap setting features soak in the blackening material.

18. A method, comprising:
disposing a blackening material over a first surface of a substrate, the substrate having the first surface and a second surface, wherein the first surface comprises at least one waveguide, the blackening material disposed between a grating and an edge of the substrate;
curing the blackening material to form a blackening section;
disposing an adhesive over the blackening section;
curing the adhesive; and
placing a cover substrate on the adhesive.

19. The method of claim 18, further comprising repeating the method on the second surface of the substrate.

20. The method of claim 18, further comprising:
singulating the waveguide from the substrate, wherein the substrate comprises a plurality of waveguides; and
forming a blackening layer over at least the edge of the substrate comprising the waveguide.
